(19) United States
(12) Patent Application Publication
(10) Pub. No.: US 2019/0242522 A1
(43) Pub. Date: Aug. 8, 2019

(54) CONNECTING DEVICE FOR A WIND TURBINE COMPONENT

(71) Applicant: Siemens Gamesa Renewable Energy A/S, Brande (DK)

(72) Inventor: JESPER MOELLER, BRANDE (DK)

(21) Appl. No.: 16/342,218

(22) PCT Filed: Oct. 13, 2017
(86) PCT No.: PCT/EP2017/076212

§ 371 Date: Apr. 16, 2019

(30) Foreign Application Priority Data
Oct. 20, 2016 (DE) 10 2016 220 626.5

(51) Int. Cl. F16M 13/06; F03D 13/10; B66C 1/10; B66C 1/62; F16M 13/02; F03D 13/40

(52) U.S. Cl. CPC F16M 13/06; F03D 13/10; B66C 1/108; F05B 2230/61; F16M 13/02; F03D 13/40; B66C 1/62

(57) ABSTRACT

A connecting device (10) for connecting a wind turbine component (100) to an apparatus (101, 102) for moving the component (100) the connecting device (10) comprises:
at least a first portion (20) designed for receiving a moving load applied to the connecting device (10) by the apparatus (101, 102) for moving the component (100),
at least a second portion (30, 32) designed for transferring the moving load from the first portion (20) to the component (100). The first and the second portions of the connecting device (10) are removably attachable to each other.

### CROSS-REFERENCE TO RELATED APPLICATIONS

This application claims priority to PCT Application No. PCT/EP2017/076212, having a filing date of Oct. 13, 2017, which is based on German Application No. 10 2016 220 626.5, having a filing date of Oct. 20, 2016, the entire contents both of which are hereby incorporated by reference.

### FIELD OF TECHNOLOGY

The following relates to a connecting device to connect a component, particularly a wind turbine component, to an apparatus for lifting the component during installation or to an apparatus for transporting the component.

### BACKGROUND

In the technical field of wind turbines installation, each of the components of a wind turbine have to be transported to the site of installation, where the components are mounted together to form the wind turbine. For the mounting, lifting of at least part of the components is normally required.

Particularly, but not exclusively, the latter apply to the sections (normally two sections or more), which constitutes the tower of the wind turbine. The sections may be cylindrical, hexagonal or of other shape.

Each tower section is transported horizontally and fixed to a transporting structure by means of two to four transport brackets attached at each of the top and bottom bases of the cylindrical section.

After arriving on the site of installation the transportation brackets are detached from the tower section and another plurality of lifting brackets are attached thereto, for connecting the tower section to a lifting apparatus, particularly to a crane, which is used to place the tower sections one over the other to form the wind turbine tower.

According to the known transport and installation procedure, lifting and transport brackets are designed for each tower section and for each turbine design. This means that transport brackets are not designed for lifting and listing brackets are not designed for transport.

This implies a plurality of inconveniences, in connection with the fact that, in general, in wind turbine projects, the tower design is always late, meaning start of design and manufacturing of the lifting and transport equipment like the transport and lifting brackets, is also starting late. In addition, the lifting equipment is to be approved by a third party, different from the manufacturer, and such procedure of approval which also take a given time. The manufacturing of lifting and transport equipment normally starts after such approval from the third party.

All this causes an excess of time and costs.

It is therefore still desirable to have an improved connecting device for a wind turbine component, in order that time costs of designing and manufacturing of the lifting and transport equipment for a component of a wind turbine, particularly a tower section, are conveniently optimized.

### SUMMARY

An aspect relates to a connecting device for moving a wind turbine component solving the above described inconveniences experimented in known lifting device.

It may be a further aspect of the present invention to provide a connecting device for moving a wind turbine component providing a higher level of standardization and flexibility with respect to the existing connecting device for moving a wind turbine component.

This aspect is solved by a connecting device according to the independent claim. The dependent claims describe advantageous developments and modifications of embodiments of the invention.

According to embodiments of the present invention, a connecting device for connecting a wind turbine component to an apparatus for moving the component the connecting device comprises:

at least a first portion designed for receiving a moving load applied to the connecting device by the apparatus for moving the component,
at least a second portion designed for transferring the moving load from the first portion to the component, wherein the first and the second portions of the connecting device are removably attachable to each other.

According to embodiments of the present invention and wording of the claims, the term “moving” encompasses both “transporting”, i.e. moving the component from the site of manufacturing to the site the installation and operative site, and “lifting”, i.e. moving the component up to the height required for installation.

Advantageously, according to embodiments of the present invention, the connecting device, which may be particularly structured in the form of a bracket, includes a first portion and a second portion. The first portion may be, after load tests and approval below a working load limit, used for a plurality of turbine components not exciding that limit. The second portion may be instead specific for each different turbine component. The multiple use of at least the first portion of the connecting device permits to save time during the design and manufacturing phases of the lifting and transport equipment, as only the second portion has to be designed and manufactured. This also permits saving materials and the relevant costs when manufacturing the connecting device.

According to embodiments of the present invention, the first and the second portions of the connecting device are removably attachable to each other by means of respective first and second complementary connecting elements. Particularly, the first and second complementary connecting elements may have matching shapes.

According to other possible embodiments of the present invention, one of the first and second complementary attaching elements is an attachment hole and the other of the first and second complementary attaching elements is a protrusion removably insertable in the hole.

Advantageously, the shapes of first and second complementary attaching elements facilitate the coupling between the first portion and the second portion of the connecting device.

According to other possible embodiments of the present invention, the first and second complementary attaching elements further include a shoulder at one end of the protrusion, the shoulder interfering with the border of the attachment hole when the first and the second portions of the connecting device are attached to each other, the first and the second portions being oriented with respect to one another in such a way that the shoulder is forced against the border of the attachment hole when the moving load is applied to the component. Advantageously, this specific shape of the first and second complementary attaching elements improves the coupling between the first and the second portions of the connecting device when the moving load is applied to the component.

According to another possible embodiments of the present invention, the attachment hole is provided on the first portion of the connecting device and is inclined with respect to the moving load of an angle greater than 0 degrees. Advantageously, this further improves the coupling between the first and the second portions of the connecting device, when the moving load is applied to the component.

According to other possible embodiments of the present invention, the second portion of the connecting device is fixable to the component by means of at least a removable fixing element. Particularly, as fixing elements a plurality of fixing bolts or screws respectively insertable in the plurality of fixing holes. Advantageously, the bolts or screw may be standard bolts or screw.

### BRIEF DESCRIPTION

Some of the embodiments will be described in detail, with references to the following Figures, wherein like designations denote like members, wherein:

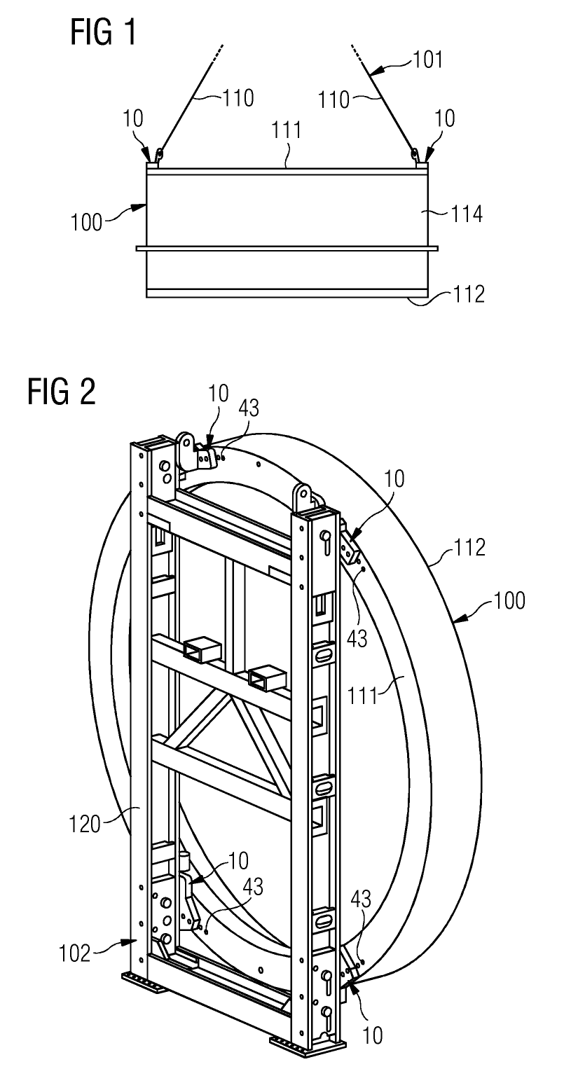

FIG. 1 shows a lateral view of a wind turbine component attached to a lifting apparatus by a connecting device according to embodiments of the present invention;

FIG. 2 shows an axonometric view of a wind turbine component attached to a transport apparatus by a connecting device according to embodiments of the present invention;

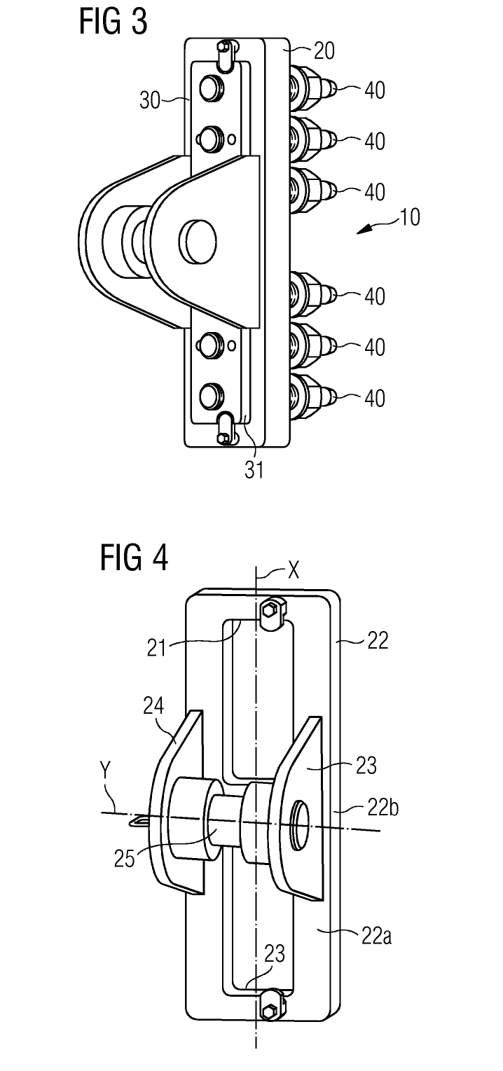

FIG. 3 shows an axonometric view of a connecting device for a wind turbine component according to embodiments of the present invention;

FIG. 4 shows an axonometric view of a first portion of the connecting device of FIG. 3;

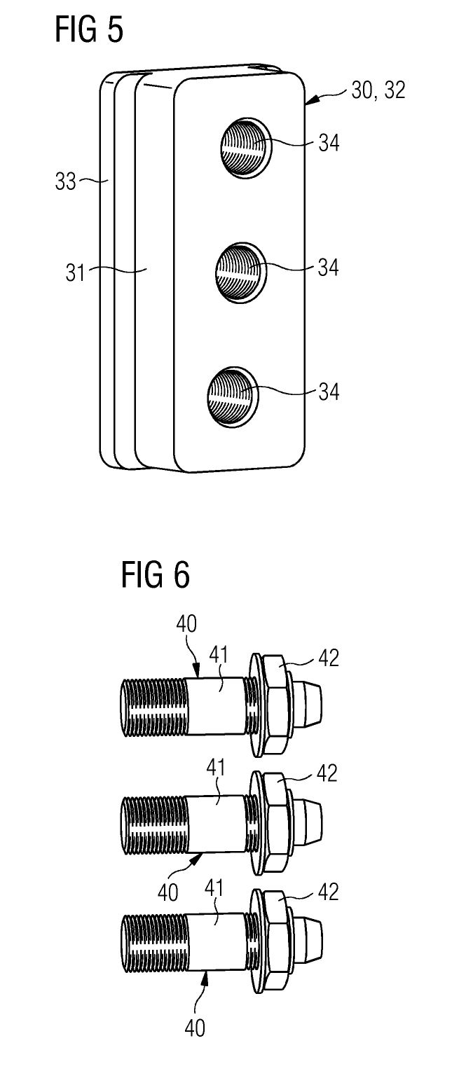

FIG. 5 shows an axonometric view of a second portion of the connecting device of FIG. 3; and

FIG. 6 shows an axonometric view of a second portion of the connecting of FIG. 3.

### DETAILED DESCRIPTION

The illustrations in the drawings are schematic. It is noted that in different figures, similar or identical elements are provided with the same reference signs.

FIGS. 1 and 2 show respectively a tower portion 100 for a wind turbine (not represented as a whole) respectively attached to an apparatus for lifting 101 and an apparatus for transporting 102. The tower portion 100 has a cylindrical shape with two opposite circular bases 111, 112 and a lateral surface 114.

According to other possible embodiments (not represented) the present invention may be adapted to other components of a wind turbine to be moved, in particular transported from a manufacturing site to an operative site and lifted up to the height required for installation.

The apparatus for lifting 101 (partially represented in FIG. 1) normally includes a crane (not represented) and a plurality of wires or ropes 110 for connecting the tower portion 100 to the crane. The apparatus for transporting 102 (partially represented in FIG. 2) include a structure 120 which is part or can be fixed to a vehicle.

In both the embodiment of FIGS. 1 and 2, the tower portion 100 is attached to the apparatus for lifting 101 or to the apparatus for transporting 102 through a connecting device 10.

In the embodiment of FIG. 1, a plurality of connecting devices 10 (two are shown in FIG. 1) are attached to one of the circular bases 111, 112 of the tower portion 100. The plurality of connecting devices 10 used to link the tower portion 100 to the wires or ropes 110 of the apparatus for lifting 101.

In the embodiment of FIG. 2, a plurality of connecting devices 10 (four are shown in FIG. 1) are attached to both the circular bases 111, 112 of the tower portion 100. The plurality of connecting devices 10 is used to link the tower portion 100 to the structure 120 of the apparatus for transporting 102.

FIGS. 3 to 6 illustrate the connecting device 10, structured in the form of a bracket.

The connecting device 10 (FIG. 3) comprises a first portion 20 designed for receiving a moving load applied to the connecting device 10 by the apparatus for lifting 101 or the apparatus for transporting 102 and a second portion 30 designed for transferring such moving load to the tower portion 100. The connecting device 10 further comprises a third portion 32 identical to the second portions 30.

The first portion 20 of the connecting device 10 is removably attachable to second portion 30 and the third portion 32.

The connecting device 10 further include a plurality of removable fixing elements 40, though which the connecting device 10 is fixable to the tower portion 100. In the embodiment of the attached FIGS. 3 to 6, the fixing elements 40 are six pin bolts, three bolts 40 being usable for fixing the second portion 30 to the tower portion 100 and the other three bolts 40 being usable for fixing the third portion 32 to the tower portion 100, as further better detailed in the following.

According to other embodiments of the present invention (not shown) the fixing elements 40 may be of any type, for example screws or normal bolts. The fixing elements 40 may be provided in any other number, i.e. one or more fixing elements 40 may be used for each of the second portion 30 and of the third portion 32.

According to a possible embodiment (not shown) the third portion 32 of the connecting device 10 is not present and the second portion 30 is fixable to the tower portion 100 through a single fixing element 40.

The first portions 20 (FIG. 4) includes a base plate 22, having two main faces 22a, 22b with a rectangular shape. In a top view orthogonal to the main faces 22a, 22b, the main faces 22a, 22b have a main symmetry axis X and a secondary symmetry axis Y. The first portions 20 further includes a first and a second through attachment holes 21, 23 being also of rectangular shape and connecting the two main faces 22a, 22b with one another. In each of the attachment holes 21, 23 one or the other of the second portion 30 and the third portion 32 of the connecting device 10 are respectively insertable, as further detailed in the following.

In symmetric positions with respect to main symmetry axis X, the first portions 20 further include two lateral plates 23, 24 attached to the base plate 22 perpendicularly to the main faces 22a, 22b. The two lateral plates 23, 24 are connected to each other by a shaft 25, distanced from the base plate 22 and parallel to the secondary symmetry axis Y. Each of the two lateral plates 23, 24 have a symmetrical shape with respect to the secondary symmetry axis Y, in such a way that, in a top view orthogonal to the main faces 22a, 22b, the axis of the shaft 25 is coincident with the secondary symmetry axis Y. The shaft is used in operation, i.e. when transporting or lifting the connecting device 10, to apply the moving load to the connecting device 10.

The moving load is applied to the connecting device 10 through the shaft 25. The moving load is applied along a direction which, with respect to the base plate 22 and therefore to the attachment holes 21, 23 is inclined of an angle greater than 0 degrees.

The base plate 22, the two lateral plates 23, 24 and the shaft 25 are dimensioned in such a way that a predefined maximum moving load acting on the shaft 25 can be borne by the connecting device 10.

The second portions 30 and the third portion 32 (FIG. 5) of the connecting device 10 are identical. Each of the second portions 30 and the third portion 32 includes a protrusion 31 removably insertable in each of the attachment holes 21, 23. In a top view, the protrusion 31 has a rectangular profile matching the shape of the attachment holes 21, 23. The dimensions of the protrusion 31 and of the attachment holes 21, 23 are such that the protrusion 31 is removably insertable in each of the attachment holes 21, 23 with a slight backlash.

The second portions 30 and the third portion 32 further includes a shoulder 33 interfering with the border of the attachment hole 21, 32 when the first portion 20 of the connecting device 10 is attached to the second portion 30 or to the third portion 32.

When the protrusion 31 is inserted in the attachment hole 21, 23, the shoulder 33 is supported on the face 22a of the base plate 22 which faces the shaft 25. In such a way, when a pulling force is applied to the connecting device 10, for example during lifting of the tower portion 100, the shoulder 33 is forced against the border of the attachment hole 21, 23, thus improving the attachment between the first portion 20 and the second portion 30 and the third portion 32 of the connecting device 10.

The attachment holes 21, 23 and the respective protrusions 31 respectively constitutes first and second complementary connecting elements, which permits the attachment between the first portion 20 and the second portion 30 and the third portion 32 of the connecting device 10.

According to other embodiments of the present invention (not represented), different first and second complementary connecting elements may be implemented. For example, only one attachment hole or more than two attachment holes may be provided on the first portion 20 of the connecting device 10, for coupling with a respective protrusions 31.

In all cases, the connecting device 10 is made of at least two portions, removably attachable to each other and respectively designed and provided for receiving the moving load and for transferring the moving load to the component 100.

In the embodiment of the attached FIGS. 3 to 6, for transferring the moving load to the component 100, the second and the third portions 30, 32 includes a plurality of threaded fixing holes 34. The fixing holes 34 are oriented in such a way that when the second and/or the third portions 30, 32 are attached to the first portion 20 of the connecting device 10, the holes 34 are parallel to the attachment 21, 23 and orthogonal to the base plate 22.

The connecting device 10 is fixable to the tower portion 100 by means of a plurality of fixing bolts 40 (FIG. 6), each insertable and coupleable in one respective fixing hole 34 the second and the third portions 30, 32 and also on a respective hole 43 provided on one of the circular bases 111, 112 of the tower portion 100.

Each bolt 40 includes a screw 41, for coupling with the fixing holes 34, 43 on the connecting device 10 and on the tower portion 100, and a nut 42 for blocking the screw 41 in its operative fixing position.

According to another possible embodiment (not shown) screw are used instead of the bolts 40.

The protrusion 31, the shoulder 33, the fixing holes 34 and the bolts 40 are dimensioned in such a way that the predefined maximum moving load acting on the first portion 20 can be transferred to the tower portion 100, when the second and the third portions 30, 32 are attached to first portion 20 of the connecting device 10.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A connecting device for connecting a wind turbine component to an apparatus for moving the component the connecting device comprising:
at least a first portion designed for receiving a moving load applied to the connecting device by the apparatus for moving the component,
at least a second portion designed for transferring the moving load from the first portion to the component,
wherein the first and the second portions of the connecting device are removably attachable to each other.

2. The connecting device according to claim 1, wherein the first and the second portions of the connecting device are removably attachable to each other by respective first and second complementary connecting elements.

3. The connecting device according to claim 2, wherein first and second complementary connecting elements have matching shapes.

4. The connecting device according to claim 2, wherein one of the first and second complementary attaching elements is an attachment hole and the other of the first and second complementary attaching elements is a protrusion removably insertable in the hole.

5. The connecting device according to claim 2, wherein said other of the first and second complementary attaching elements further include a shoulder at one end of the protrusion, the shoulder interfering with the border of the attachment hole when the first and the second portions of the connecting device are attached to each other, the first and the second portions being oriented with respect to one another in such a way that the shoulder is forced against the border of the attachment hole when the moving load is applied to the component.

6. The connecting device according to claim 4, wherein the attachment hole is provided on the first portion of the connecting device, the attachment hole being inclined with respect to the moving load of an angle greater than 0 degrees.

7. The connecting device according to claim 6, wherein the attachment hole is a through hole.

8. The connecting device according to claim 4, wherein of respective first complementary connecting elements comprises a second attachment hole and the connecting device comprises a third portion designed to cooperate with the second portion for transferring the moving load to the component, third portion having a protrusion removably insertable in the second attachment hole.

9. The connecting device according to claim 6, wherein the second portion of the connecting device is fixable to the component by at least a removable fixing element.

10. The connecting device according to claim 9, wherein the second portion of the connecting device includes a plurality of fixing holes, the connecting device being fixable to the component by a plurality of fixing bolts or screws respectively insertable in the plurality of fixing holes.
